(19) United States
(12) Patent Application Publication
(10) Pub. No.: US 2026/0302459 A1
(43) Pub. Date: Oct. 1, 2026

(54) BATTERY MODULE AND MANUFACTURING METHOD THEREOF

(71) Applicant: HONDA MOTOR CO., LTD., Tokyo (JP)

(72) Inventor: Toshiyuki ARIGA, Saitama (JP)

(21) Appl. No.: 19/578,877

(22) Filed: Mar. 26, 2026

(30) Foreign Application Priority Data
Mar. 28, 2025 (JP) 2025-057009

(51) Int. Cl. H01M 50/193; H01M 10/0525; H01M 10/058; H01M 50/186; H01M 50/533; H01M 50/54

(52) U.S. Cl. CPC H01M 50/193; H01M 10/0525; H01M 10/058; H01M 50/186; H01M 50/533; H01M 50/54

(57) ABSTRACT

A battery module according to an embodiment of the present invention is a battery module including a battery cell laminated body in which a number of battery cells are laminated together. Each of the battery cells includes an electrode laminated body, an outer casing configured to contain the electrode laminated body therein, a positive electrode tab, and a negative electrode tab. The outer casing includes an electrode laminated body container configured to contain the electrode laminated body therein and a seal part configured to seal the electrode laminated body container. A resin material is injected between any two seal parts of the plurality of battery cells in the battery cell laminated body.

This application is based on and claims the benefit of priority from Japanese Patent Application No. 2025-057009, filed on 28 Mar. 2025, the content of which is incorporated herein by reference.

### BACKGROUND OF THE INVENTION

### Field of the Invention

The present invention relates to a battery module and a manufacturing method thereof.

### Related Art

In recent years, secondary batteries capable of contributing to improving energy efficiency have been studied and developed, so that more people are able to secure access to affordable, reliable, sustainable, and advanced energy.

Known secondary batteries include a laminated-type battery in which an outer casing contains therein an electrode laminated body obtained by laminating a positive electrode layer and a negative electrode layer, while an electrolyte is interposed therebetween. As the outer casing, a laminate film is widely used. As a battery module using laminated-type battery cells, it has been considered to dispose a fixation member shaped to have a prescribed shape at a seal part of an outer casing of the battery cells (see Patent Document 1).

Patent Document 1: Japanese Unexamined Patent Application, Publication No. 2024-134783

### SUMMARY OF THE INVENTION

In relation to the above, for the technology related to secondary batteries, one of the problems is enhancement of safety. Secondary batteries using a laminate film for an outer casing require that a seal part of the laminate film is sealed so as not to open apart. However, in battery modules including a battery cell laminated body obtained by laminating a plurality of battery cells together, because a large amount of heat is generated at the time of charging and discharging, the sealing property of the seal part may be degraded by factors such as the generated heat, and the seal part may easily open apart.

An object of the present invention is to provide a battery module in which the seal part does not easily open apart and which can stably be used for a long period of time, and a manufacturing method therefor.

1. A battery module including a battery cell laminated body in which a plurality of battery cells are laminated together, wherein each of the battery cells includes an electrode laminated body, an outer casing configured to contain the electrode laminated body therein, a positive electrode tab, and a negative electrode tab, the electrode laminated body includes a positive electrode layer including a positive electrode current collector and a negative electrode layer including a negative electrode current collector, the outer casing includes an electrode laminated body container configured to contain the electrode laminated body therein and a seal part configured to seal the electrode laminated body container, each of seal parts being the seal part extends in a direction orthogonal to a lamination direction of the electrode laminated body, one of end parts of the positive electrode tab is connected to the positive electrode current collector, and an other end part thereof is extended to an outside through the seal part, one of end parts of the negative electrode tab is connected to the negative electrode current collector, and an other end part thereof is extended to the outside through the seal part, and each of the seal parts is covered by a resin material.

In the battery module set forth in (1), because the seal parts of the battery cells are injected with the resin material, the seal parts do not easily open apart. In addition, the resin material protects the electrode laminated bodies inside the battery cells from physical shock and vibration. Further, because the heat generated in the battery cells is released to the outside by the resin material, the heat does not easily get confined inside the battery cells. Thus, deterioration of the battery cells which may be caused by the heat does not easily occur. Furthermore, because the resin material fixes the battery cells, the positions of the battery cells do not easily shift. Consequently, it is possible to stably use the battery module set forth in (1) for a long period of time.

2. The battery module according to (1) wherein the resin material is injected between any two of the seal parts of the plurality of battery cells in the battery cell laminated body.

In the battery module set forth in (2), because the resin material is injected between any two of the seal parts of the plurality of battery cells, the seal parts are prevented from easily opening apart, with higher certainty.

3. The battery module according to (1) or (2), wherein the resin material covers an end part of each of the seal parts.

In the battery module set forth in (3), because the resin material covers as far as the end part of each of the seal parts, the seal parts are prevented from easily opening apart, with higher certainty.

4. The battery module according to any one of (1) to (3), wherein the resin material is injected as far as a position in touch with each of electrode laminated body containers being the electrode laminated body container.

In the battery module set forth in (4), because the resin material is injected as far as the position in touch with each of the electrode laminated body containers, the seal parts are prevented from easily opening apart, with higher certainty.

5. The battery module according to any one of (1) to (4), wherein the seal parts of any two of the battery cells positioned adjacent to each other in the lamination direction are connected together by a connection member.

In the battery module set forth in (5), because the seal parts of any two of the battery cells positioned adjacent to each other in the lamination direction are connected together by the connection member, the seal parts do not easily open apart, and the positions of the battery cells do not easily shift.

6. The battery module according to any one of (1) to (5), wherein the resin material has a tensile strength of 15 MPa or higher.

In the battery module set forth in (6), because the resin material has the high tensile strength, even when the gap between a seal part and another seal part increases or decreases due to contractions or expansions of the battery cells, the resin material does not easily get damaged. Consequently, it is possible to stably prevent the seal parts from opening apart for a long period of time.

7. The battery module according to any one of (1) to (6), wherein the resin material has an elongation-at-break value of 200% or higher.

In the battery module set forth in (7), because the resin material has the high elongation-at-break value, when the gap between a seal part and another seal part increases or decreases due to contractions or expansions of the battery cells, the resin material stretches or shrinks in accordance with the gap. Consequently, it is possible to prevent the seal parts from opening apart, with higher certainty.

8. The battery module according to any one of (1) to (7), wherein the resin material is a polyurea resin.

In the battery module set forth in (8), the resin material is a polyurea resin and has a high tensile strength and a high elongation-at-break value. Thus, it is possible to prevent the seal parts from opening apart for a long period of time, with higher certainty.

9. The battery module according to any one of (1) to (8), wherein a cushion is provided between any two of the plurality of battery cells.

In the battery module set forth in (9), even when the battery cells expand or contract, there is little change in the thickness of the battery cell laminated body. Thus, it is possible to prevent the seal parts from opening apart, with even higher certainty.

10. The battery module according to any one of (1) to (9), wherein each of the battery cells is a non-aqueous solvent secondary battery.

In the battery module set forth in (10), even if the battery cells are non-aqueous solvent secondary batteries, leakage of the non-aqueous solvent which may be caused by the seal parts opening apart does not easily occur.

11. The battery module according to any one of (1) to (10), wherein each of the battery cells is a lithium metal secondary battery.

In the battery module set forth in (11), even if the battery cells are lithium metal secondary batteries, and the battery cells expand and contract due to precipitation of lithium caused by charging and discharging and ionization of lithium caused by discharging, it is possible to prevent the seal parts from opening apart.

12. A battery module manufacturing method including: a preparing step of preparing a plurality of battery cells each including an electrode laminated body, an outer casing configured to contain the electrode laminated body therein, a positive electrode tab, and a negative electrode tab, wherein the electrode laminated body includes a positive electrode layer including a positive electrode current collector and a negative electrode layer including a negative electrode current collector, the outer casing includes a container configured to contain the electrode laminated body therein and a seal part configured to seal the container, each of seal parts being the seal part extends in a direction orthogonal to a lamination direction of the electrode laminated body, one of end parts of the positive electrode tab is connected to the positive electrode current collector, and an other end part thereof is extended to an outside of the outer casing, one of end parts of the negative electrode tab is connected to the negative electrode current collector, and an other end part thereof is extended to the outside of the outer casing; a laminating step of obtaining a battery cell laminated body by laminating the plurality of battery cells together; and a covering step of covering each of the seal parts of the plurality of battery cells in the battery cell laminated body by using a resin material.

According to the battery module manufacturing method set forth in (12), in the covering step, the seal parts of the battery cells are covered by the resin material. Thus, the seal parts of the battery cells do not easily open apart.

13. The battery module manufacturing method according to (12) wherein a method for covering that uses the resin material is a method including: spraying a liquid composition containing a room-temperature curable resin between any two of the seal parts of the battery cells; and curing the room-temperature curable resin in the liquid composition.

According to the battery module manufacturing method set forth in (13), the room-temperature curable resin is used as an ingredient of the resin material. Thus, it is possible to inject, without fail, the resin material between any two of the seal parts.

15. The battery module manufacturing method according to (12) or (13), including, prior to the covering step, a fixing step of fixing the battery cells by putting a bar-like member through the seal parts of the plurality of battery cells.

According to the battery module manufacturing method set forth in (14), the plurality of battery cells are fixed. As a result, it is possible to inhibit positional shifts of the battery cells during manufacturing and to thus inject, without fail, the resin material between any two of the seal parts.

According to the present invention, it is possible to provide the battery module in which the seal parts do not easily open apart and which can stably be used for a long period of time, and the manufacturing method therefor.

### BRIEF DESCRIPTION OF THE DRAWINGS

FIG. 1 is a perspective view showing an example of a battery module according to an embodiment of the present invention;

FIG. 2 is a cross-sectional view taken at line II-II in FIG. 1;

FIG. 3 is an enlarged cross-sectional view of FIG. 2;

FIG. 4 is a cross-sectional view taken at line IV-IV in FIG. 1;

FIG. 5 is a perspective view showing an example of a battery cell used in the battery module according to the embodiment of the present invention;

FIG. 6 is a perspective view showing a laminating step in a battery module manufacturing method according to an embodiment of the present invention;

FIG. 7 is a perspective view showing a covering step in the battery module manufacturing method according to the embodiment of the present invention;

FIG. 8 is a cross-sectional view showing another example of the battery module according to the embodiment of the present invention; and

FIG. 9 is a partial perspective view showing another example of the battery cell used in the battery module according to the embodiment of the present invention.

### DETAILED DESCRIPTION OF THE INVENTION

The following will describe embodiments of the present invention with reference to the drawings. The embodiments described below, however, are examples of the present invention, and the present invention is not limited by the following examples.

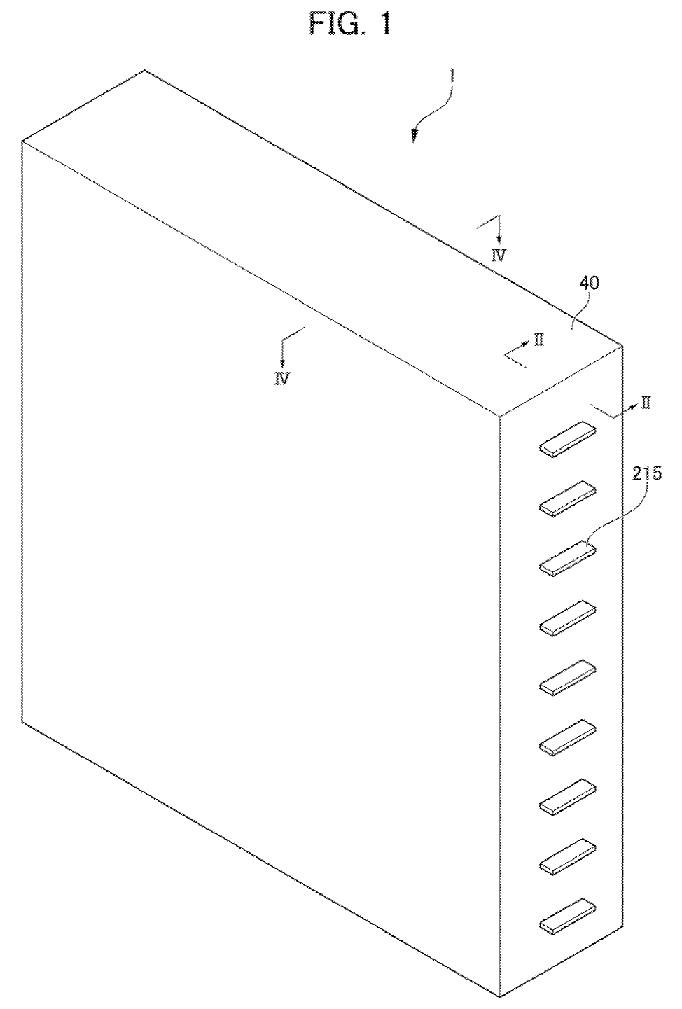

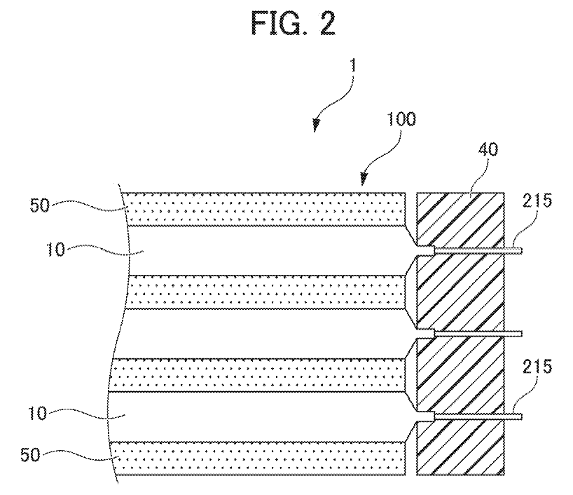

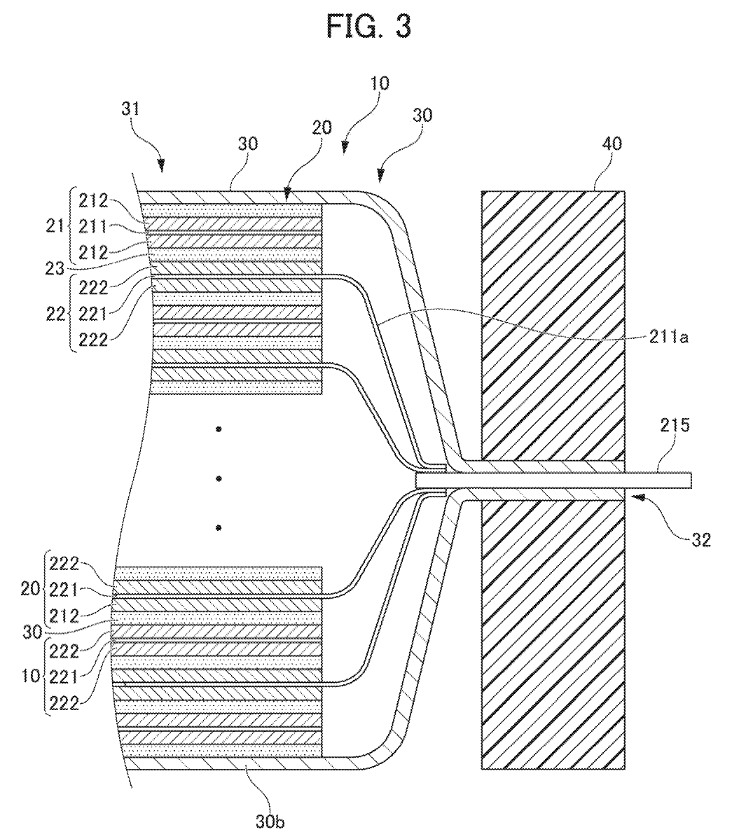

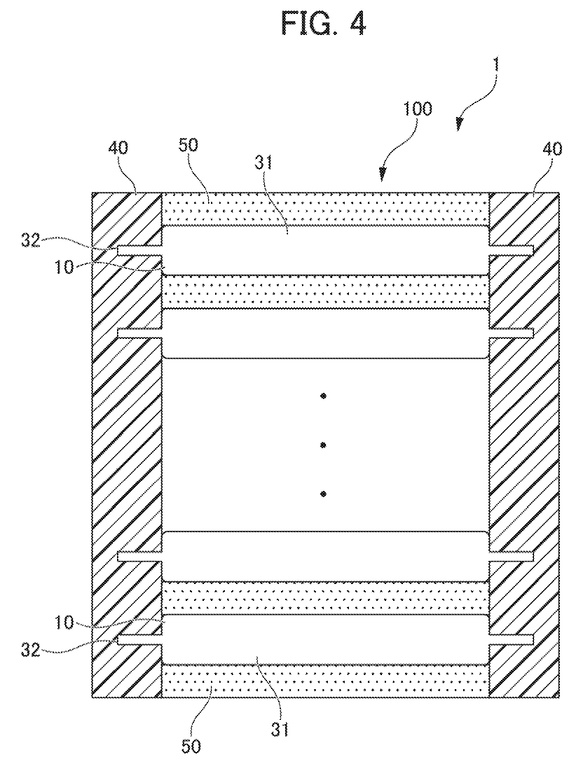

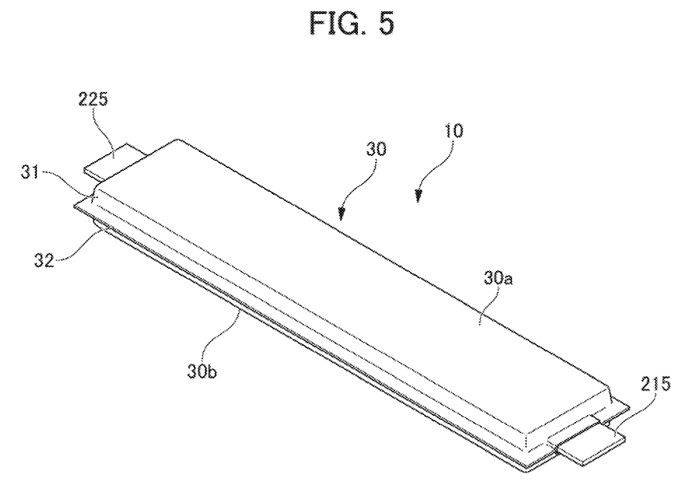

FIG. 1 is a perspective view showing an example of a battery module according to an embodiment of the present invention. FIG. 2 is a cross-sectional view taken at line II-II in FIG. 1. FIG. 3 is an enlarged cross-sectional view of FIG. 2. FIG. 4 is a cross-sectional view taken at line IV-IV in FIG. 1. FIG. 5 is a perspective view showing an example of a battery cell used in the battery module.

As shown in FIGS. 2 and 4, a battery module 1 includes a battery cell laminated body 100 in which a plurality of battery cells 10 are laminated together.

Each of the battery cells 10 includes an electrode laminated body 20, an outer casing 30 containing the electrode laminated body 20, a positive electrode tab 215, and a negative electrode tab 225. The positive electrode tab 215 and the negative electrode tab 225 are provided at end parts on the opposite sides from each other.

Each of the electrode laminated bodies 20 includes a positive electrode layer 21 and a negative electrode layer 22. Provided between the positive electrode layer 21 and the negative electrode layer 22 is a separator 23 impregnated with an electrolyte.

The positive electrode layer 21 includes a positive electrode current collector 211 and positive electrode active material layers 212. The positive electrode active material layers 212 are laminated on both surfaces of the positive electrode current collector 211. The positive electrode current collector 211 has a positive electrode current collector extension part 211a connected to the positive electrode tab.

The negative electrode layer 22 includes a negative electrode current collector 221 and negative electrode active material layers 222. The negative electrode active material layers 222 are laminated on both surfaces of the negative electrode current collector 221. The negative electrode current collector 221 has a negative electrode current collector extension part connected to the negative electrode tab 225.

The outer casing 30 includes an electrode laminated body container 31 containing the electrode laminated body therein and a seal part 32 configured to seal the electrode laminated body container 31. The seal part 32 extends in a direction orthogonal to the lamination direction of the electrode laminated body 20. The seal parts 32 of any two of the battery cells 10 positioned adjacent to each other in the lamination direction may be connected together by a connection member. As the connection member, it is possible to use, for example, a bar-like member, a wire, or a rivet pin button.

Of the positive electrode tab 215, one of end parts is connected to the positive electrode current collector extension part 211a, and the other end part is extended to the outside through the seal part 32. Of the negative electrode tab 225, one of end parts is connected to the negative electrode current collector, and the other end part is extended to the outside through the seal part.

In the battery cell laminated body 100, a resin material 40 is injected between any two of the seal parts 32 of the plurality of battery cells 10. The resin material 40 covers end parts of each of the seal parts 32. The battery cell laminated body 100 is covered by the resin material 40 in such a manner that only the positive electrode tabs 215 and the negative electrode tabs 225 are exposed to the outside.

In the battery cell laminated body 100, a cushion 50 is provided between any two of the plurality of battery cells 10.

Examples of a material of the positive electrode current collectors 211 include aluminum, an aluminum alloy, stainless steel, nickel, iron, and titanium.

As a material of the positive electrode active material layers 212, it is possible to use a composition containing a positive electrode active material, a conductive additive, and a binder. Examples of the positive electrode active material include: lithium cobalt oxide (LiCoO₂), lithium nickel oxide (LiNiO₂), lithium nickel manganese cobalt oxide (NMC: LiNiₚMn_{q}CoᵣO₂ (p + q + r = 1)), LiNiₚAl_{q}CoᵣO₂ (p + q + r = 1), lithium manganese oxide (LiMn₂O₄), a heteroatom-substituted Li-Mn spinel expressed as Li₁₊ₓMn_{2-x-y}MO₄ (where x + y = 2, M = at least one selected from Al, Mg, Co, Fe, Ni, and Zn), lithium titanium oxide (an oxide containing Li and Ti), lithium phosphate (LiMPO₄, M = at least one selected from Fe, Mn, Co, and Ni). Examples of the conductive additive include: carbon black, natural graphite, carbon fibers, and carbon nanotubes. Examples of the binder include a nitrile polymer, a polyester polymer, an acrylic acid polymer, a cellulose polymer, a styrene polymer, a styrene butadiene polymer, a vinyl acetate polymer, a urethane polymer, a vinylidene fluoride polymer, and a fluoro ethylene polymer.

Examples of a material of the negative electrode current collector 221 includes copper, a copper alloy, nickel, and stainless steel.

Each of the negative electrode active material layers 222 is a layer that, when being charged, generates a metal layer containing lithium. As the negative electrode active material layers 222, it is possible to use lithium and a metal, a semi-metal, carbon, or an oxide that forms an alloy with lithium. Examples of the metal or the semi-metal that forms the alloy with lithium include Mg, Si, Au, Ag, In, Ge, Sn, Pb, Al, and Zn. It is sufficient when the negative electrode layer 22 generates the metal layer containing lithium, when being charged. Thus, instead of using the negative electrode active material layers 222, it is also acceptable to cause the negative electrode current collector 221 to generate a metal layer containing lithium.

The electrolyte contains an organic solvent. As the organic solvent, it is possible to use, for example, a cyclic carbonate, a chain carbonate, a cyclic ether, a chain ether, a hydrofluoroether, an aromatic ether, a sulfone, a cyclic ester, a chain carboxylic ester, or a nitrile. Examples of the cyclic carbonate include ethylene carbonate, propylene carbonate, vinylene carbonate, fluoroethylene carbonate, and the like. Examples of the chain carbonate include dimethyl carbonate, diethyl carbonate, and ethyl methyl carbonate or the like. Examples of the cyclic ether include tetrahydrofuran, 2-methyl tetrahydrofuran, tetrahydropyran, 1,3-dioxolane, 4-methyl-1, 3-dioxolane, and the like. Examples of the chain ether include 1,2-dimethoxyethane, 1,2-diethoxyethane, ethoxymethoxyethane, diethyl ether, and the like. Examples of the hydrofluoroether include 1,1,2,2-tetrafluoroethyl-2,2,2-trifluoroethyl ether, 1,1,2,2-tetrafluoroethyl-2,2,3,3-tetrafluoropropyl ether, bis(2,2,2-trifluoroethyl)ether, 1,2-bis(1,1,2,2-tetrafluoroethoxy)ethane, and the like. Examples of the aromatic ether include anisole. Examples of the sulfone include sulfolane, methylsulfolane, and the like. Examples of the cyclic ester include γ-butyrolactone and the like. Examples of the chain carboxylic ester include acetate esters, butyrate esters, propionic acid esters, and the like. Examples of the nitrile include acetonitrile, propionitrile, and the like. As the organic solvent, one type may be used alone, or two or more types may be used in combination.

The electrolyte contains a lithium salt. Examples of the lithium salt include, LiPF₆, LiBF₄, LiClO₄, LiAsF₆, LiCF₃SO₃, LiC(CF₃SO₂)₃, LiN(CF₃SO₂)₂(LiTFSI), LiN(FSO₂)₂(LiFSI), and LiBC₄O₈ or the like. As the lithium salt, one type may be used alone, or two or more types may be used in combination. The concentration of the electrolyte may be in the range of 1.0 to 4.0 mol/L, for example.

As the separator, for example, it is possible to use a porous sheet or a non-woven sheet. Examples of a material of the porous sheet include a polyolefin such as polyethylene or polypropylene, aramid, polyimide, fluororesin, and the like. Examples of a material of the non-woven sheet include glass fibers, cellulose fibers, and the like.

The outer casing 30 includes two laminate films 30a and 30b. The electrode laminated body container 31 is formed by sandwiching the electrode laminated body 20 between the two laminate films 30a and 30b. The seal part 32 is formed by superimposing and fusing the four opposing sides of each of the laminate films 30a and 30b together in one-to-one correspondence.

Although not illustrated, each of the laminate films 30a and 30b includes a metal layer, an inner resin layer disposed on the inner side of the metal layer, and an outer resin layer disposed on the outer side of the metal layer. As a material of the metal layer, it is possible to use aluminum, for example. As a material of the inner resin layer, it is possible to use, for example, polyethylene, polypropylene, an ethylene-vinyl acetate copolymer, or polyurethane. As a material of the outer resin layer, it is possible to use polyimide, polyester, polycarbonate, an acrylic resin, or a fluororesin.

Possible configurations of the outer casing 30 are not limited to those including the two laminate films 30a and 30b. For example, it is acceptable to form the outer casing 30 by using a single laminate film. It is also acceptable to form the electrode laminated body container 31 by folding a single laminate film so as to sandwich the electrode laminated body 20 therebetween, and to form the seal part 32 by superimposing and fusing together the three opposing sides in one-to-one correspondence.

The resin material 40 may have a tensile strength of 15 MPa or higher, although possible embodiments are not limited to this example. Although an upper limit thereof is not particularly limited, the tensile strength may be 100 MPa or lower, for example. The tensile strength is a value measured in accordance with ASTM D-412.

The resin material 40 may have an elongation-at-break value of 200% or higher, although possible embodiments are not limited to this example. Although an upper limit thereof is not particularly limited, the elongation-at-break value may be 1000% or lower, for example. The elongation-at-break value is a value measured in accordance with ASTM D-412.

As the resin material 40, for example, it is possible to use a polyurea resin or a polyurethane resin. The resin material 40 may be a polyurea resin

The cushion is disposed between any two of the plurality of battery cells in the battery cell laminated body 100. The cushions 50 have an effect of reducing the amount of a change in the thickness of the battery cell laminated body 100 (the dimension of the battery cells 10 in the lamination direction) that may be caused by expansions or contractions of the battery cells 10. Each of the cushions 50 is formed by using an elastic member.

Next, a method for manufacturing the battery module 1 of the present embodiment will be explained. The method for manufacturing the battery module 1 includes, for example, a preparing step, a laminating step, a fixing step, and a covering step.

The preparing step is a step of preparing the plurality of battery cells 10.

The laminating step is a step of obtaining the battery cell laminated body 100 by laminating the plurality of battery cells 10 together.

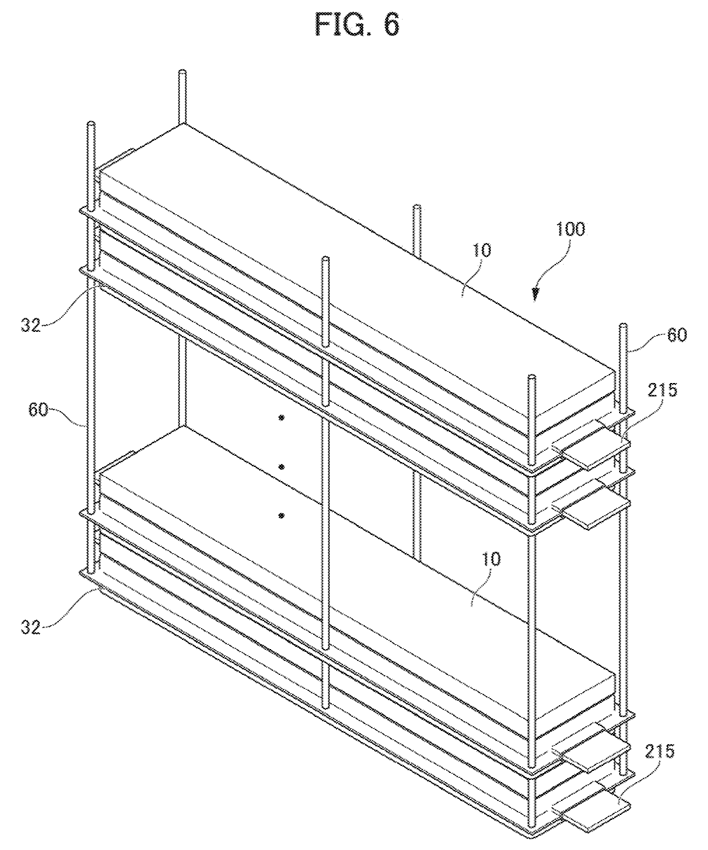

Th fixing step is, as shown in FIG. 6, a step of putting bar-like members 60 through the seal parts 32 of the plurality of battery cells 10 structuring the battery cell laminated body 100. As a result, the battery cells 10 in the battery cell laminated body 100 are fixed. The bar-like members 60 are put through, by forming through holes in advance in prescribed positions of the seal parts 32 of the battery cells 10 and inserting the bar-like members 60 in the through holes. Possible materials of the bar-like members 60 are not particularly limited. It is possible to use a resin, a metal, or ceramics, for example.

The covering step is a step of covering the seal parts 32 of the battery cells 10 in the battery cell laminated body 100, by using the resin material 40. As for the method for covering that uses the resin material 40, it is possible to use a method including: spraying a liquid composition containing a room-temperature curable resin between any two of the seal parts 32 of the battery cells 10; and curing the room-temperature curable resin in the liquid composition.

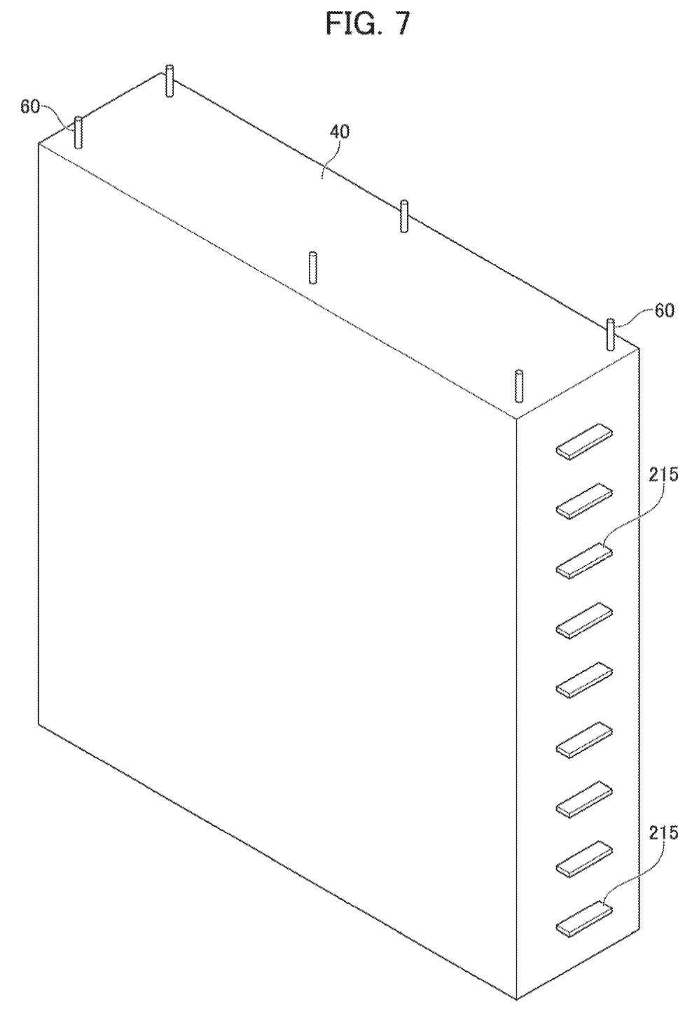

In this manner, as shown in FIG. 7, the battery module 1 is obtained in which the battery cell laminated body 100 is covered by the resin material 40. The bar-like members 60 may be removed as necessary or may be used as a connection member.

In the battery module 1 of the present embodiment configured as described above, because the seal parts 32 of the battery cells 10 are covered by the resin material 40, the seal parts 32 do not easily open apart. In addition, the resin material 40 protects the electrode laminated bodies 20 inside the battery cells 10 from physical shock and vibration. Further, because the heat generated in the battery cells 10 is released to the outside by the resin material 40, the heat does not easily get confined inside the battery cells 10. Thus, deterioration of the battery cells 10 which may be caused by the heat does not easily occur. Furthermore, because the resin material 40 fixes the battery cells 10, the positions of the battery cells 10 do not easily shift. Consequently, it is possible to stably use the battery module of the present embodiment for a long period of time.

In the battery module 1 of the present embodiment, there is no need to dispose a fixation member. As a result, it is possible to increase the percentage of the volume of the battery laminated body in the space within the module and to thus improve an energy density.

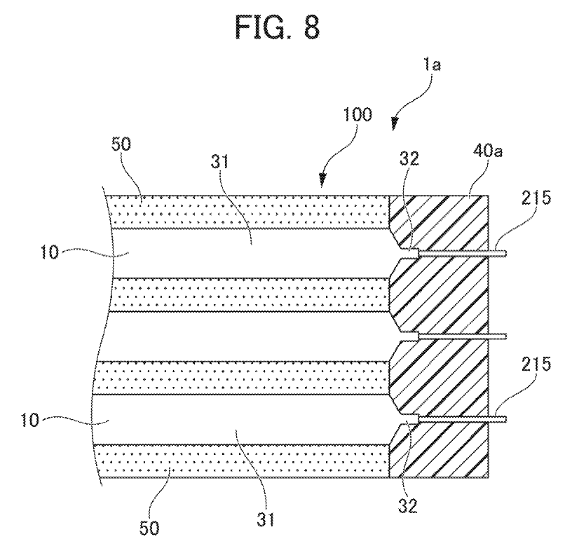

In the battery module 1 of the present embodiment, the resin material 40 is injected between any two of the seal parts 32 of the plurality of battery cells 10 in the battery cell laminated body 100. Thus, the seal parts 32 are prevented from easily opening apart, with higher certainty. In addition, because the resin material 40 covers as far as the end part of each of the seal parts 32, the seal parts are prevented from easily opening apart, with higher certainty. As shown in FIG. 8, the resin material 40 may be injected as far as the position in touch with each of the electrode laminated body containers 31. With this configuration, the seal parts 32 are prevented from easily opening apart, with higher certainty. It should be noted, however, that depending on the size of the seal parts 32, the end parts of the seal parts 32 may be exposed from the resin material 40, and the resin material 40 does not necessarily need to be injected as far as the position in touch with each of the electrode laminated body containers 31.

In the battery module 1 of the present embodiment, when the seal parts 32 of any two of the battery cells 10 positioned adjacent to each other in the lamination direction are connected together by the connection member, the seal parts 32 do not easily open apart, and the positions of the battery cells 10 do not easily shift.

In the battery module 1 of the present embodiment, if the resin material 40 has a high tensile strength such as 15 MPa or higher, even when the gap between a seal part 32 and another seal part 32 increases or decreases due to contractions or expansions of the battery cells 10, the resin material 40 does not easily get damaged. Consequently, it is possible to stably prevent the seal parts 32 from opening apart for a long period of time.

In the battery module 1 of the present embodiment, if the resin material 40 has a high elongation-at-break value such as 200% or higher, when the gap between a seal part 32 and another seal part 32 increases or decreases due to contractions or expansions of the battery cells 10, the resin material 40 stretches or shrinks in accordance with the gap. Consequently, it is possible to prevent the seal parts 32 from opening apart, with higher certainty.

In the battery module 1 of the present embodiment, if the resin material 40 is a polyurea resin, because the resin material 40 has a high tensile strength and a high elongation-at-break value, it is possible to prevent the seal parts 32 from opening apart for a long period of time, with higher certainty.

In the battery module 1 of the present embodiment, when the cushion 50 is disposed between any two of the plurality of battery cells 10, even when the battery cells 10 expand or contract, because there is little change in the thickness of the battery cell laminated body 100, it is possible to prevent the seal parts 32 from opening apart, with even higher certainty.

In the battery module 1 of the present embodiment, even if the battery cells 10 are non-aqueous solvent secondary batteries, leakage of the non-aqueous solvent which may be caused by the seal parts 32 opening apart does not easily occur.

In the battery module 1 of the present embodiment, even if the battery cells 10 are lithium metal secondary batteries, and the battery cells 10 expand and contract due to precipitation of lithium caused by charging and discharging and ionization of lithium caused by discharging, it is possible to prevent the seal parts 32 from opening apart.

According to the battery module manufacturing method of the present embodiment, in the covering step, the resin material 40 is injected between any two of the seal parts 32 of the plurality of battery cells 10, the seal parts 32 of the battery cells 10 do not easily open apart.

In the battery module manufacturing method of the present embodiment, when a room-temperature curable resin is used as an ingredient of the resin material 40, it is possible to inject, without fail, the resin material 40 between any two of the seal parts 32.

According to the battery module manufacturing method of the present embodiment, prior to the covering step, the fixing step of fixing the battery cells 10 is performed by putting the bar-like members 60 through the seal parts 32 of the plurality of battery cells 10. As a result, it is possible to inhibit positional shifts of the battery cells 10 during manufacturing and to thus inject, without fail, the resin material 40 between any two of the seal parts 32. It should be noted, however, that as long as it is possible to inhibit the positional shifts of the battery cells 10 during the covering step, there is no need to fix the battery cells 10 by using the bar-like members 60.

Certain preferable embodiments of the present invention have thus been explained; however, the present invention is not limited by the embodiments described above. Modifications and improvements within the scope capable of achieving the object of the present invention are included in the present invention.

For example, according to the battery module manufacturing method of the present embodiment, the seal parts 32 of the battery cells 10 in the battery cell laminated body 100 are covered by the resin material 40; however, possible embodiments are not limited to this example. It is also acceptable to laminate together battery cells 10 in which the seal parts 32 are covered by the resin material 40. Further, in the present embodiment, the liquid electrolyte is used as the electrolyte of the battery cells 10; however, the electrolyte may be a solid electrolyte. Furthermore, in the present embodiment, the positive electrode active material layers 212 are laminated on both surfaces of the positive electrode current collector 211; however, it is sufficient when the positive electrode active material layer 212 is formed on the surface positioned on the negative electrode layer 22 side. The positive electrode active material layer 212 may be formed only on one of the surfaces of the positive electrode current collector 211. The negative electrode active material layers 222 are laminated on both surfaces of the negative electrode current collector 221; however, it is sufficient when the negative electrode active material layer 222 is formed on the surface positioned on the positive electrode layer 21 side. The negative electrode active material layer 222 may be formed only on one of the surfaces of the negative electrode current collector 221.

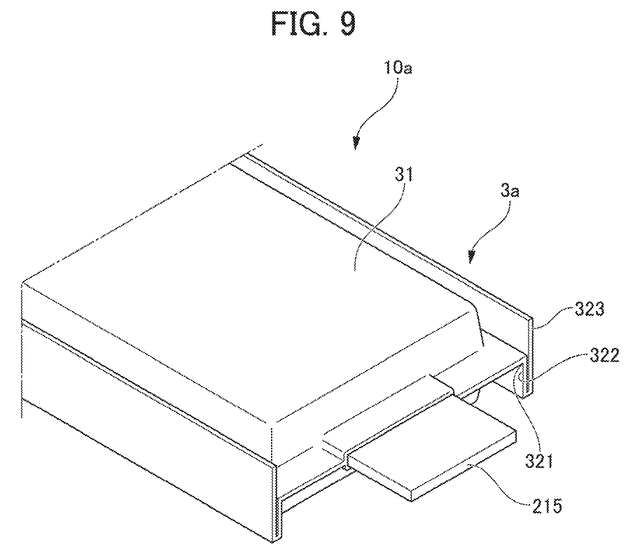

Furthermore, although the seal parts 32 are linear in the present embodiment, the seal parts 32 may be folded. For example, as shown in FIG. 9, it is acceptable to configure a seal part 32a so as to have a folded part 321 and be shaped to have a first region 322 extending toward one side in terms of the lamination direction of the electrode laminated body 20; and a second region 323 extending from the end part of the first region 322 on the one side, toward the other side opposite from the one side. Because of having a long length, the seal part 32adoes not easily open apart.

### EXPLANATION OF REFERENCE NUMERALS

1: battery module

10: battery cell

20: electrode laminated body

21: positive electrode layer

22: negative electrode layer

23: separator

30: outer casing

30a: laminate film

30b: laminate film

31: electrode laminated body container

32: seal part

40: resin material

50: cushion

60: bar-like member

100: battery cell laminated body

211: positive electrode current collector

211a: positive electrode current collector extension part

212: positive electrode active material layer

215: positive electrode tab

221: negative electrode current collector

222: negative electrode active material layer

225: negative electrode tab

What is claimed is:

1. Battery module comprising
a battery cell laminated body in which a plurality of battery cells are laminated together, wherein
each of the battery cells includes an electrode laminated body, an outer casing configured to contain the electrode laminated body therein, a positive electrode tab, and a negative electrode tab,
the electrode laminated body includes a positive electrode layer including a positive electrode current collector and a negative electrode layer including a negative electrode current collector,
the outer casing includes an electrode laminated body container configured to contain the electrode laminated body therein and a seal part configured to seal the electrode laminated body container,
each of seal parts being the seal part extends in a direction orthogonal to a lamination direction of the electrode laminated body,
one of end parts of the positive electrode tab is connected to the positive electrode current collector, and an other end part thereof is extended to an outside through the seal part,
one of end parts of the negative electrode tab is connected to the negative electrode current collector, and an other end part thereof is extended to the outside through the seal part, and
each of the seal parts is covered by a resin material.

2. The battery module according to claim 1, wherein the resin material is injected between any two of the seal parts of the plurality of battery cells in the battery cell laminated body.

3. The battery module according to claim 1, wherein the resin material covers an end part of each of the seal parts.

4. The battery module according to claim 1, wherein the resin material is injected as far as a position in touch with each of electrode laminated body containers being the electrode laminated body container.

5. The battery module according to claim 1, wherein the seal parts of any two of the battery cells positioned adjacent to each other in the lamination direction are connected together by a connection member.

6. The battery module according to claim 1, wherein the resin material has a tensile strength of 15 MPa or higher.

7. The battery module according to claim 1, wherein the resin material has an elongation-at-break value of 200% or higher.

8. The battery module according to claim 1, wherein the resin material is a polyurea resin.

9. The battery module according to claim 1, wherein a cushion is provided between any two of the plurality of battery cells.

10. The battery module according to claim 1, wherein each of the battery cells is a non-aqueous solvent secondary battery.

11. The battery module according to claim 1, wherein each of the battery cells is a lithium metal secondary battery.

12. A battery module manufacturing method comprising:
a preparing step of preparing a plurality of battery cells each including an electrode laminated body, an outer casing configured to contain the electrode laminated body therein, a positive electrode tab, and a negative electrode tab, wherein the electrode laminated body includes a positive electrode layer including a positive electrode current collector and a negative electrode layer including a negative electrode current collector, the outer casing includes a container configured to contain the electrode laminated body therein and a seal part configured to seal the container, each of seal parts being the seal part extends in a direction orthogonal to a lamination direction of the electrode laminated body, one of end parts of the positive electrode tab is connected to the positive electrode current collector, and an other end part thereof is extended to an outside of the outer casing, one of end parts of the negative electrode tab is connected to the negative electrode current collector, and an other end part thereof is extended to the outside of the outer casing;
a laminating step of obtaining a battery cell laminated body by laminating the plurality of battery cells together; and
a covering step of covering each of the seal parts of the plurality of battery cells in the battery cell laminated body by using a resin material.

13. The battery module manufacturing method according to claim 12 wherein a method for covering that uses the resin material is a method comprising: spraying a liquid composition containing a room-temperature curable resin between any two of the seal parts of the battery cells; and curing the room-temperature curable resin in the liquid composition.

14. The battery module manufacturing method according to claim 12, comprising, prior to the covering step, a fixing step of fixing the battery cells by putting a bar-like member through the seal parts of the plurality of battery cells.
